(19) United States
(12) Patent Application Publication
(10) Pub. No.: US 2015/0183096 A1
(43) Pub. Date: Jul. 2, 2015

(54) SCREWDRIVER

(71) Applicants: Fu Tai Hua Industry (Shenzhen) Co., Ltd., Shenzhen (CN); HON HAI PRECISION INDUSTRY CO., LTD., New Taipei (TW)

(72) Inventor: CHUAN WANG, Shenzhen (CN)

(21) Appl. No.: 14/529,373

(22) Filed: Oct. 31, 2014

(30) Foreign Application Priority Data
Dec. 27, 2013 (CN) 201310733309.7

(51) Int. Cl. B25B 23/00; B25B 23/10

(52) U.S. Cl. CPC B25B 23/0007; B25B 23/101

(57) ABSTRACT

A screwdriver includes a substantially tubular housing, a grip mechanism, an adjusting member and a screwdriver head. The screwdriver head and the grip mechanism are mounted within the housing. The grip mechanism includes a number of grip rods, a gripping portion of the grip rods extend beyond a first tube wall end of the housing. The adjusting member is movable along the outer tube wall surface of the housing to engage the gripping portion of the grip rods and move the grip rods to a gripping position with the gripping portion of each grip rod moved toward the engaging portion of the screwdriver head. A grip member is attached to a distal end of the gripping portion and the grip members cooperate to grab a screw engaged by the engaging portion of the screwdriver head when in the gripping position.

### CROSS-REFERENCE TO RELATED APPLICATIONS

This application claims priority to Chinese Patent Application No. 201310733309.7 filed on Dec. 27, 2013, the contents of which are incorporated by reference herein.

### FIELD

The subject matter herein generally relates to screwdrivers.

### BACKGROUND

Screwdrivers are common tools for turning screws. However, if a screw is damaged, it is difficult for using the screwdrivers to turn the damaged screw.

### BRIEF DESCRIPTION OF THE DRAWINGS

Implementations of the present technology will now be described, by way of example only, with reference to the attached figures.

FIG. 1 is an isometric view of an example embodiment of a screwdriver.

FIG. 2 is an exploded view of an example embodiment of the screwdriver of FIG. 1.

FIG. 3 is a cross-sectional view of an example of the screwdriver of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout disclosure will now be presented. The term “outside” refers to a region that is beyond the outermost confines of a physical object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”, it specifically indicates open-ended inclusion or membership in a so-described combination, group, series and the like.

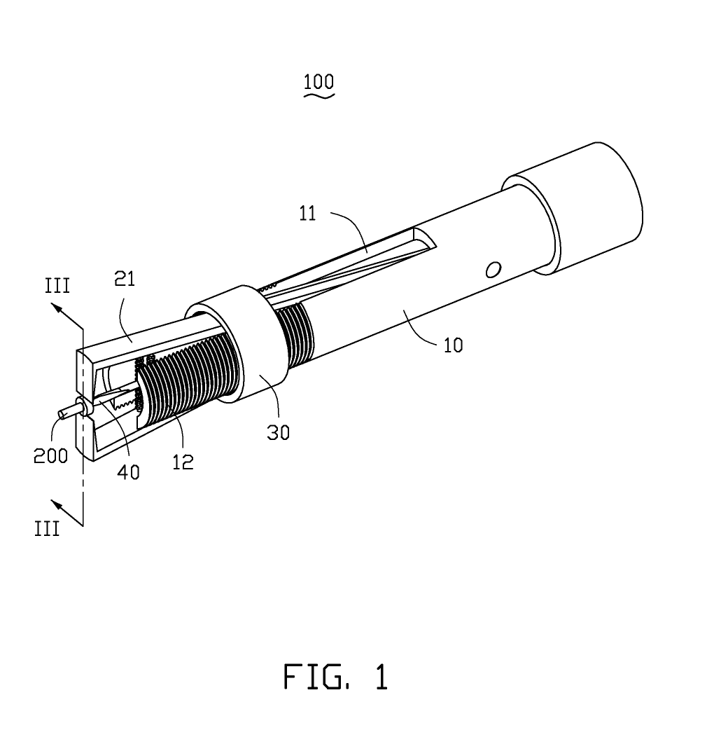

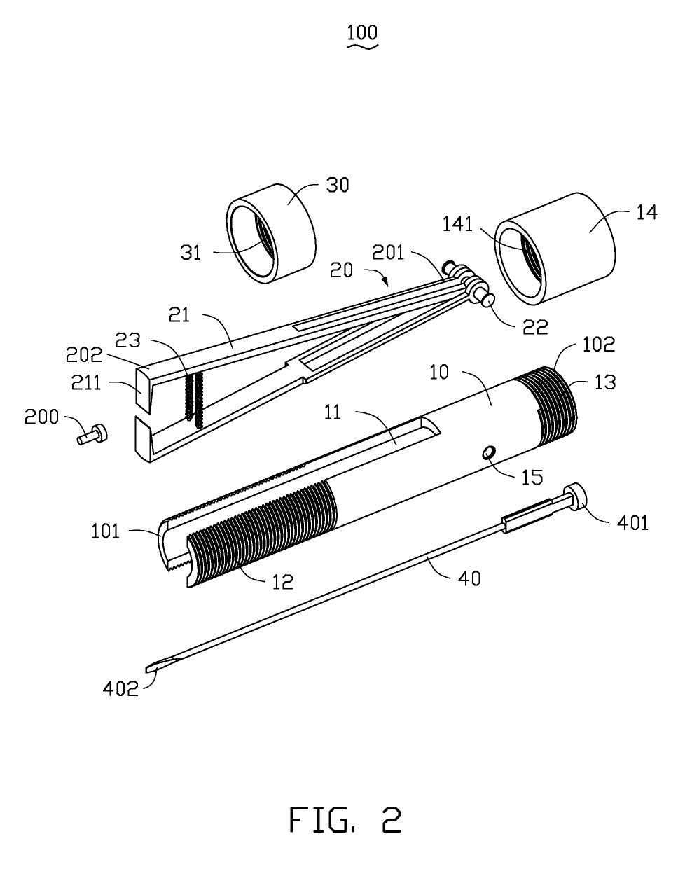

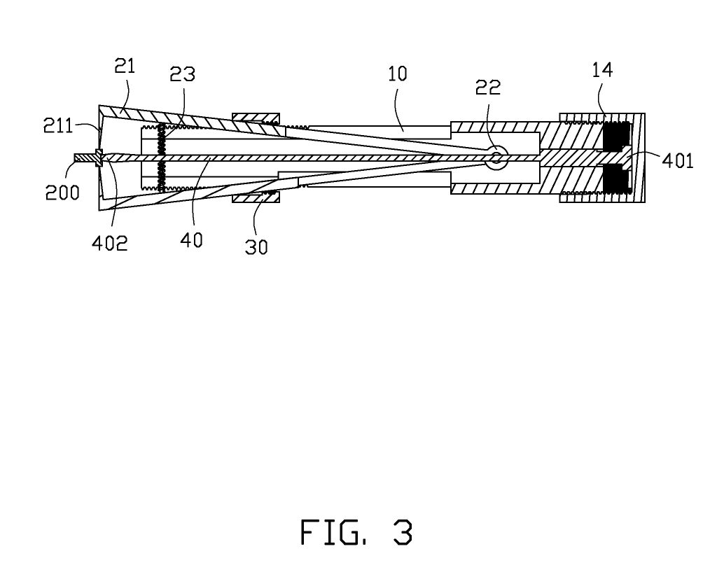

FIG. 1 illustrates an isometric view of an example embodiment of a screwdriver 100 for turning screws 200. In at least one embodiment, the screwdriver 100 can include a substantially tubular housing 10, a grip mechanism 20 (as shown in FIG. 2), an adjusting member 30 and a screwdriver head 40. Further referring to FIG. 2, the housing 10 has a tube wall with an inner tube wall surface and an outer tube wall surface extending from a first tube wall end 101 to a second tube wall end 102. The screwdriver head 40 includes a mounting portion 401 and an engaging portion 402 opposite the mounting portion 401. The screwdriver head 40 can be mounted within the tubular housing 10. The mounting portion 401 can be coupled to the tube wall, and the engaging portion 402 can extends beyond the first tube wall end 101 to engage with the screw 200. The grip mechanism 20 is mounted within the housing 10 and can include a number of grip rods 21, a gripping portion 202 of each grip rod 21 extends beyond the first tube wall end 101. The adjusting member 30 is movably positioned on the outer tube wall surface of the housing 10 to engage the gripping portion 202 of each of the plurality of grip rods 21 and move the grip rods 21 to a gripping position (as shown in FIG. 3) with the gripping portion 202 of each of the number of the grip rods 21 moved toward the engaging portion 402 of the screwdriver head 40. A grip member 211 is attached to the distal end of the gripping portion 202 of each gripping rod 21 and the grip members cooperate to grip the screw 200 engaged by the engaging portion 402 of the screwdriver head 40 when in the gripping position.

In this embodiment, the tube wall of the housing further defines a number of housing openings extending from the first tube wall end 101 toward the second tube wall end 102, the gripping portion 202 of each of the number of the grip rods 21 extends outward through one of the number of housing openings beyond the outer wall surface of the housing 10. The outer tube wall surface of the housing 10 further defines a first screw thread 12 at the first tube wall end 101, and defines a second screw thread 13 at the second tube wall end 102 The housing 10 further can include a fixing member 14. The fixing member 14 is substantially tubular, and one end of the fixing member 14 is closed. An inner screw thread 141 is defined in the inner wall surface of the fixing member 14. Further referring to FIG. 3, the fixing member 14 is detachably mounted to the housing 10 by engaging the inner screw thread 141 with the second screw thread 13. The mounting portion 401 of the screwdriver head 40 is mounted to the fixing member 14. A length of the engaging portion 402 extending out of the housing 10 can be adjusted by screwing in or screwing out the fixing member 14 along the second screw thread 13. In this embodiment, different heads 40 can be mounted to the screwdriver 100 by changing the fixing members 14 with different heads 40. Two through holes 15 are further symmetrical defined in the tube wall of the housing 10.

In this embodiment, the grip mechanism 20 further can include a connecting member 22, and an elastic member 23. A first end 201 of each grip rods 21 are rotateablely connected to the connecting member 22. The gripping portion 202 of each of the grip rods 21 are connected to one end of the elastic member 23, thus the grip rods 21 are separated by the elastic member 23. Two ends of the connecting member 22 are respectively fixed to the two through holes 15 of the housing 10, therefore, the grip rods 21 are connected to the housing 10. In other embodiments, the grip rods can be unibody designed by using metal material, and the elastic member 23 can be omitted.

In this embodiment, the adjusting member 30 is a sleeve. An inner wall surface of the adjusting member 30 defines a screw portion 31 corresponding to the first screw thread 12. The adjusting member 30 is movably positioned on the outer tube wall surface of the housing 10 by engaging the screw portion 31 with the first screw thread 12. When the adjusting member 30 moves along the housing 10 in a direction away from the second screw thread 13, the adjusting member 30 engages an extending portion of the gripping portion 202 of each grip rod 21 and moves the grip rods 21 to the gripping position with the grip members 211 of each grip rod 21 moved toward the engaging portion 402 of the screwdriver head 40. At the same time, the elastic member 23 is compressed.

When using the screwdriver 100 to turn the screw 200, a user can put the screwdriver 200 in a position that the grip members 211 face to the screw 200. The user can further turn the adjusting member 31 toward the screw 200 along the first screw thread 12, thus the adjusting member 31 can drive the grip rods 21 to move close to each other until the grip members 211 grips the screw 200 tightly. At this time, the elastic member 23 is compressed. Then the user can turn the fixing member 14 to adjust the length of the engaging portion 402 extending out of the housing 10 until the engaging portion 402 engages the screw 200. When the user turns the housing 10, the engaging portion 402 of the screwdriver head 40 and the grip member 211 cooperate to turn the screw 200. If the user turns the adjusting member 31 toward the direction away from the screw 200 along the first screw thread 12, the grip rods 21 are released by the adjusting member 31 and are separated by the elastic member 23. Therefore, the screw 200 can be released by the grip members 211.

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including, the full extent established by the broad general meaning of the terms used in the claims. It will therefore be appreciated that the embodiments described above may be modified within the scope of the claims.

What is claimed is:

1. A screwdriver comprising:
a substantially tubular housing, the housing having a tube wall with an inner tube wall surface and outer tube wall surface and extending from a first tube wall end to a second tube wall end;
a screwdriver head mounted within the tubular housing, the screwdriver head having a mounting portion coupled to the tube wall and an engaging portion opposite the mounting portion and extending beyond the first tube wall end, the engaging portion being configured to engage with a screw;
a grip mechanism mounted within the housing and having a plurality of grip rods, a gripping portion of the grip rods extending beyond the first tube wall end; and
an adjusting member movably positioned on the outer tube wall surface;
wherein, there is a plurality of housing openings defined in the tube wall extending from the first tube wall end toward the second tube wall end;
wherein, the gripping portion of each of the plurality of grip rods extend outward through one of the plurality of housing openings beyond the outer wall surface;
wherein, the adjusting member is movable along the outer tube wall surface to engage the gripping portion of the plurality of grip rods and move the grip rods to a gripping position with the gripping portion of each of the plurality of grip rods moved toward the engaging portion of the screwdriver head; and
wherein, there is a grip member attached to the distal end of the gripping portion of each of the gripping rods and the grip members cooperate to grab a screw engaged by the engaging portion of the screwdriver head when in the gripping position.

2. The screwdriver of claim 1, wherein the outer tube wall surface of the housing defines a first screw thread at the first tube wall end, an inner wall surface of the adjusting member defines a screw portion corresponding to the first screw thread, the adjusting member is positioned on the housing by engaging the screw portion with the first screw thread.

3. The screwdriver of claim 1, wherein the outer tube wall surface of the housing defines a second screw thread at the second tube wall end, the housing further comprises a fixing member, the fixing member is substantially tubular and one end of the fixing member is closed, the engaging portion of the screwdriver head is mounted to the fixing member; an inner wall surface of the fixing member defines an inner screw thread corresponding to the second screw thread; the fixing member is mounted to the housing by engaging the inner screw thread with the second screw thread.

4. The screwdriver of claim 1, wherein the grip mechanism further comprises a connecting member, an end of each of the grip rods opposite to the gripping portion are connected by the connecting member, the tube wall of the housing further defines a plurality of through holes, ends of the connecting member are respectively connected to the through holes; at least one elastic member is connected between the gripping portion of the grip rods extending out of the handle.

5. The screw driver of claim 1, wherein the grip rods are unibody designed.

6. The screw driver of claim 3, wherein different screwdriver heads are capable of being mounted to the screwdriver by changing the fixing members with different screwdriver heads.
